(19) United States
(12) Patent Application Publication
(10) Pub. No.: US 2008/0317243 A1
(43) Pub. Date: Dec. 25, 2008

(54) LOW COMPLEXITY ENCRYPTION METHOD FOR CONTENT THAT IS CODED BY A RATELESS CODE

(76) Inventor: Sean A. Ramprashad, Los Altos, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/055,934

(22) Filed: Mar. 26, 2008

Related U.S. Application Data
(60) Provisional application No. 60/909,225, filed on Mar. 30, 2007.

(51) Int. Cl. H04L 9/06

(52) U.S. Cl. 380/29

(57) ABSTRACT

A method and apparatus is disclosed herein for a low complexity method of securing content that is coded by a rateless code whereby it is noted that it is sufficient to encrypt only a subset of the ratelessly coded packets. In one embodiment, the method comprises performing rateless coding on a first set of blocks of data to produce ratelessly encoded blocks of data and performing encryption on a subset of the ratelessly encoded blocks of data based on a degree value for each of the ratelessly encoded blocks of data.

### PRIORITY

The present patent application claims priority to and incorporates by reference the corresponding provisional patent application Ser. No. 60/909,225, titled, “A Low Complexity Encryption Method For Content That Is Coded By A Rateless Code,” filed on Mar. 30, 2007.

### FIELD OF THE INVENTION

The present invention relates to the field of encryption; more particularly, the present invention relates to performing encryption for content that is coded by a rateless coder.

### BACKGROUND OF THE INVENTION

Rateless codes provide a means by which information can be coded before transmission so as to make it more robust to losses in transmission, or to make it amenable to a variety of transmission scenarios whereby content is received my multiple users in an asynchronous fashion and/or without prior knowledge of transmission loss statistics. Specifically, Rateless Codes, similar to “Fixed-Rate Codes” such as classic Block and Convolutional Codes, produce “coded” symbols of information. For purposes herein, symbols may be bits, bytes, packets, etc. Coding is done is such a way that a recipient can reconstruct some finite amount, or all, of original content using only a proper subset of coded symbols, i.e., “coded” symbols can be lost in transmission yet information about the original content is preserved. Rateless codes allow for construction of coded symbols in an on-demand basis without knowing ahead of time which proper subset or subsets of symbols may be received and/or which may be lost.

For example, for some original content of “K” bytes, one can create, via a fixed-rate code, a set of “N” coded bytes, where N>K. Such coded bytes contain redundancy such that a user can reconstruct (for best performing codes termed maximum distance separable codes) the original content using any subset of K coded bytes. This would mean if all N coded bytes were transmitted to the user, and “M” coded bytes were lost during transmission, where M≦(N−K), the user could still recover the original content. In such an application, rateless codes and fixed-rate codes form a wide class of what are known as error/erasure correcting codes given their ability to preserve information in the presence of losses.

Fixed-rate codes, for a given code, are designed to produce a known value of the ratio “K/N”. This ratio is the “rate” of the fixed rate code. In the ideal/best setting this enables one to correct a fraction (N−K)/N of symbol losses in the coded content of N symbols. Error detection and error correction may also be joint functionalities provided by such codes. Codes may also have less error/erasure correcting capability, i.e. may only be able to correct reliably a fraction “F”≦(N−K)/K of errors.

Rateless codes provide a means whereby a system can take a finite amount “K” of original content and produce a practically infinite number of “coded” blocks for transmission to one or more users. In this case, there is no concept of “rate” or no fixed number “N” of coded blocks. This approach can have a basic set of advantages over fixed-rate codes in scenarios where the transmission of coded symbols to one or more users is uncoordinated, e.g., transmissions originate at one or multiple transmitters, and/or multiple receivers are receiving the same content, over different time periods. The codes can also be of lower encoding and decoding complexity relative to fixed-rate codes.

However, for a given known number of losses in coded content, or bound on the number of losses in coded content, fixed-rate codes on average require fewer number of coded blocks to be received in order to recover a given amount of original information. That is, fixed-rate codes have lower overhead than rateless codes and, therefore, are more efficient. Asymptotically, rateless codes can however come close to the performance of fixed-rate codes as “K” approaches infinity.

### Operation of a Rateless Code

A rateless code takes a number of “original” blocks, also termed message blocks, “A(1), . . . , A(K)” and produces a stream of coded blocks:

“C(1), C(2), . . . , C(N), C(N+1), . . . ”

To do so, there is a basic underlying “rateless operation” to produce such coded blocks. This may be enhanced with a precoding stage using fixed-rate codes as in Raptor Codes.

The basic rateless operation is described below and illustrated in FIG. 1:
1. To generate the coded block “C(k)” select an integer value dₖ, where 1≦dₖ≦K.
   a. For purposes herein, dₖ is termed a “degree” value which is selected at random according to a “degree distribution”.
   b. This degree distribution “p” specifies the probability of such degree values, i.e. p(n)=probability that dₖ=n.
   c. Degree values are selected in an independent and identically distributed fashion.
   d. The design of the distribution “p(n)” is a critical underlying design parameter of the scheme. There are numerous examples available.
2. Select at random dₖ distinct original blocks from the “K” possible blocks, i.e.

A(b(1,k)), A(b(2,k)), . . . , A(b(dₖ,k))

where index values are b(j,k), where 1≦b(j,k)≦K for all j=1, . . . , dₖ, and index values are unique, i.e. b(j,k)≠b(i,k) for all 1≦j≦i<dₖ
3. XOR the selected blocks, i.e. (“+” below and for purposes herein refers to the Exclusive OR (XOR) function)

C(k)=A(b(1,k))+A(b(2,k))+ . . . +A(b(dₖ,k))

As mentioned, the rateless system can also be enhanced using a fixed-rate code as a pre-coder. FIG. 2 illustrates a rateless system that uses a fixed-rate code of rate K/N. In such a system, the “preceding” step first takes the original blocks “A(1), . . . , A(K)”, precedes them using a fixed-rate code, and thus produces preceded blocks

P(1), . . . , P(N)

An unequal error protection version of this operation can be also be used as described in Ulas C. Kozat and Sean A. Ramprashad; “Unequal Error Protection Rateless Codes for Scalable Information Delivery in Mobile Networks,” Proceedings of IEEE Infocom-2007 (minisymposium paper), Anchorage, Ak., 2007.

These precoded blocks are then used as input to the rateless coding operation above, where precoded blocks (not original blocks) are XOR-ed to produce ratelessly encoded blocks, i.e.

C(k)=P(b(1,k))+P(b(2,k))+ . . . +P(b(dₖ,k)), where 1≦dₖ≦N

Note, in some designs, the fixed-rate code used for preceding may be systematic, i.e. a subset of K of the N blocks P(1), . . . , P(N) represent the original message blocks and the remaining (N−K) blocks are termed “parity” blocks that are generated by mathematical combinations of two or more of the original message blocks. Such an arrangement is shown in FIG. 3, where (without loss in generality) P(j)=A(j) for j=1, . . . , K for illustration.

In all cases, each of the rateless coded blocks require an identifier that can be used to tell the recipient which original (or pre-coded) blocks are XOR-ed within the coded block. This information is needed so that the recipient knows how to use the coded block in the decoding of the rateless code.

One approach to providing such information is for the receiver to have the same random process (or simply process) of selecting the degree values “dₖ” and block selections b(j,k). A sufficient block identifier in such a case is simply the value “k”, which can be appended (with a low overhead) to the coded block as in FIG. 4.

Referring to FIG. 4, all of coded blocks c(1) . . . c(k) have a block identifier where the identifier for c(j) is the integer “j”, simply appended into a known area of the block of information. For example, the integer block identifier “k” is appended to the information of coded block c(k), the block identifier 2 is appended to the information of coded block c(2), and the block identifier 1 is appended to the information of coded block c(1). Such information could be part of a standard header that is added to a block of information and is in general a small or trivial overhead. These identifiers allow users to simply receive transmissions, in an uncoordinated fashion or lossy fashion, yet through the block identifier be able to identify which ratelessly coded block is being received. By knowing which block, if the user has the block selection and degree selection algorithm the user can generate the identity of which pre-coder and/or original blocks were XOR-ed to produce the packet.

Another approach is simply to have a header stating the block selection values b(i,j). This, of course, would require more overhead.

### Decoding Rateless Codes

The decoding operation, given a pre-coding stage, is shown in FIG. 5. Referring to FIG. 5, a user has a subset of “G” coded blocks, “C(a₁), . . . , C(a_{G})”, where each block is received and identified. The user now wants to recover all (or some) of the original blocks “{A(1), . . . , A(K)}” from the received coded blocks.

Each of the received coded blocks includes a block identifier. For example, coded block c(a₁) has a block identifier of a₁. Coded block c(a₂) has a block identifier of a₂. This occurs for all the coded blocks including the last received coded block c(a_{G}), which has a block identifier of a_{g}.

The coded blocks are passed through a decoding operation by a decode rateless stage 501 to decode the rateless coding procedure performed during encoding. One can use for example a low complexity “Belief Propagation” procedure or Maximum Likelihood Decoding. One can view this decoding operation as the inversion of a linear system (with all linear coefficients being either “0” or “1”) in Galois Field 2 (additions are defined via XOR with 0+0=0, 1+1=0, 1+0=1, 0+1=1) whereby the received packets are linear combinations of the original (or pre-coded) packets. This decoding operation may yield only a subset of “N” pre-Patent coded blocks referred to as P(f₁), P(f₂) . . . , P(f_{N}) (or only a subset of the “K” original blocks if no pre-coding was used referred to as A(1), A(2) . . . , A(k)). The operation may also be able to recover all blocks. This depends on what rateless coded blocks were received and/or the decoding operation. The decoding operation can also be done incrementally as new blocks are received.

If a precoding step was used, an additional decoding operation of the fixed rate code used as the pre-coder may be required. Either at the end of the rateless decoding process, or incrementally with the rateless decoding procedure, or in an iterative fashion with the rateless decoding procedure, decoding is performed as needed. Therefore, the precoded blocks are put through the appropriate decoder for the fixed-rate code, such as decode preceding block 502. In this case, lost blocks are repaired by the fixed-rate code and some or the entire original content may be received. If too many pre-coding blocks are missing, only a subset of the original content may be received. All or a subset of original blocks are referred to as A(1), A(2) . . . , A(k)).

### Basic Connections to Encryption

The relationship between error correcting codes and cryptology has been noted previously. Cryptosystems also “code” information as do error/erasure correcting codes such as rateless and fixed-rate codes. In fact, some cryptosystems are based specifically on the use of, or on types of, error correcting codes that are by nature hard to decode. If such an error correcting code design is itself unknown to an attacker (the design of the fixed rate code and/or code selection from a family of codes is a shared secret between sender and intended recipient), then breaking the system requires testing a large number of “hard to decode” possibilities. This, with a proper design, renders the system itself hard to break.

Some cryptosystems are based on simple “XOR-ing” operations, as are used in stream ciphers. Basically, if one has some information symbols “A(1), A(2), . . . ”, one can use a ciphertext “Ω” (a symbol in itself), and produce a sequence of coded symbols “C(1), C(2), . . . ” where C(k)=A(k)+Ω. For purposes herein, “+” can be a bit-wise “XOR” operation in GF(2) (GF=Galois Field). The cipher Q is the shared secret between sender and intended recipient. The ciphertext and/or XOR operation can be adapted in many ways, e.g. recursively applied to sequences of information symbols.

These cipher systems tend to be less complex, but also easier to break, since an attacker may be able to probabilistically infer the cipher text Ω from many observations on C(k). Rateless codes are also based on such XOR-ing operations, though such operations are between different subsets of the original content, not with a cipher text. Rateless codes have low-complexity methods of decoding, which is an advantage for error/erasure correction, but a disadvantage for encryption. But, again, rateless codes do not use a fixed cipher. Rather since one is XOR-ing between two or more original message symbols, i.e. as mentioned above coded symbols are of the form “A(k₁)+A(k₂)+ . . . +A(k_{d})” where “d” is a number known as the “degree” of the operation, inferring a cipher text is not one of the weaknesses with rateless codes. There are though other weaknesses.

### SUMMARY OF THE INVENTION

A method and apparatus is disclosed herein for a low complexity method of securing content that is coded by a rateless code whereby it is noted that it is sufficient to encrypt only a subset of the ratelessly coded packets. In one embodiment, the method comprises performing rateless coding on a first set of blocks of data to produce ratelessly encoded blocks of data and performing encryption on a subset of the ratelessly encoded blocks of data based on a degree value for each of the ratelessly encoded blocks of data.

### BRIEF DESCRIPTION OF THE DRAWINGS

The present invention will be understood more fully from the detailed description given below and from the accompanying drawings of various embodiments of the invention and prior art, which, however, should not be taken to limit the invention to the specific embodiments, but are for explanation and understanding only.

FIG. 1 illustrates a basic rateless coding operation.

FIG. 2 illustrates a rateless code with a pre-coding stage.

FIG. 3 illustrates a rateless code with a systematic pre-coding stage.

FIG. 4 illustrates a rateless code where coded blocks have an identifier.

FIG. 5 illustrates a decoding procedure for a rateless code.

FIG. 6 illustrates encrypting original blocks before rateless coding.

FIG. 7 illustrates encrypting coded blocks after a rateless coding stage.

FIG. 8 is a flow diagram of one embodiment of a process that encrypts coded blocks after a rateless coding stage.

FIG. 9 illustrates an approach that applies encryption only to block identifiers.

FIG. 10 is a flow diagram of one embodiment of a process that performs encryption of odd degree values after rateless coding operations which include a pre-coder.

FIG. 11 is a flow diagram of one embodiment of a process that performs decryption/decoding corresponding to the encryption/encoding of FIG. 10.

FIG. 12 is a flow diagram of one embodiment of a process that performs encryption of odd degree values after rateless coding operations as well as identifier encryption.

FIG. 13 is a flow diagram of one embodiment of the process of FIG. 12 with the addition of hiding knowledge of the random number generator or method used to generate the degree values and block selections.

FIG. 14 is a flow diagram of one embodiment of the process of FIG. 13 modified to include a more general decision as to whether or not to encrypt.

FIG. 15 is a block diagram of one embodiment of a computer system.

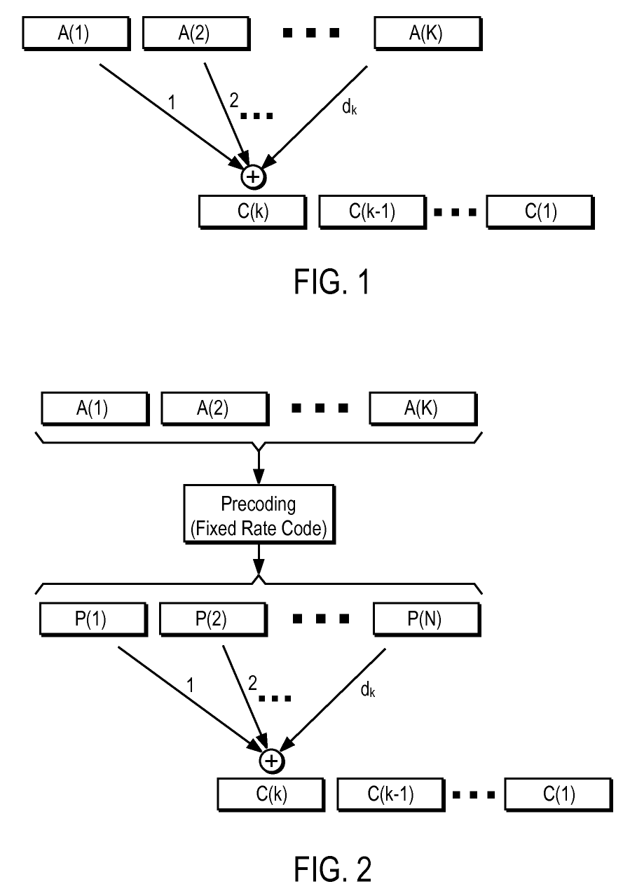

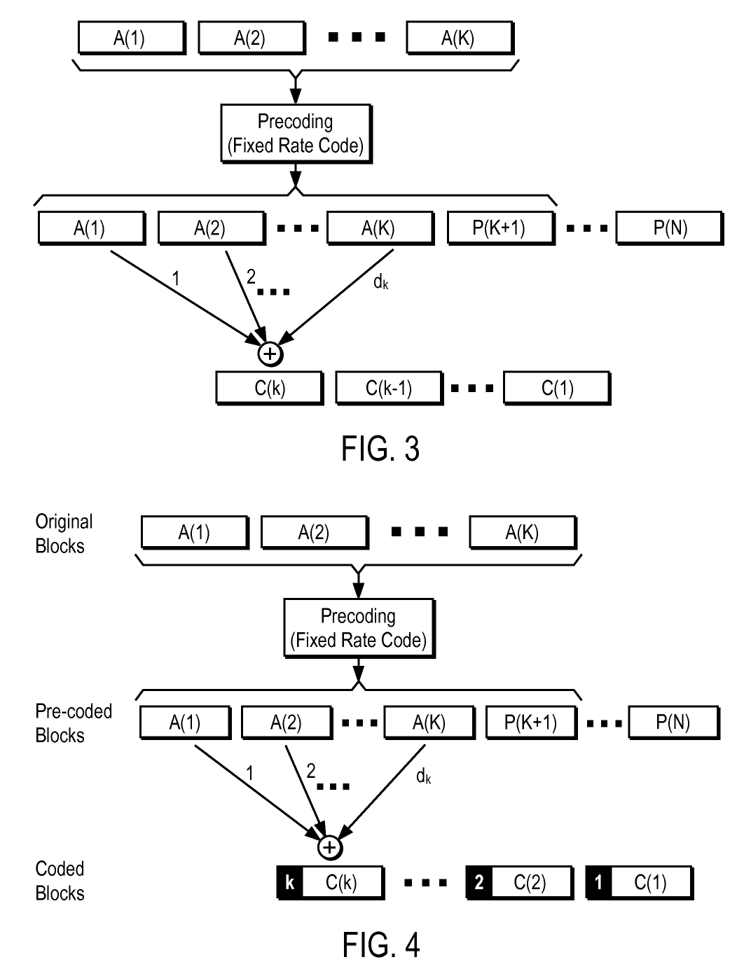

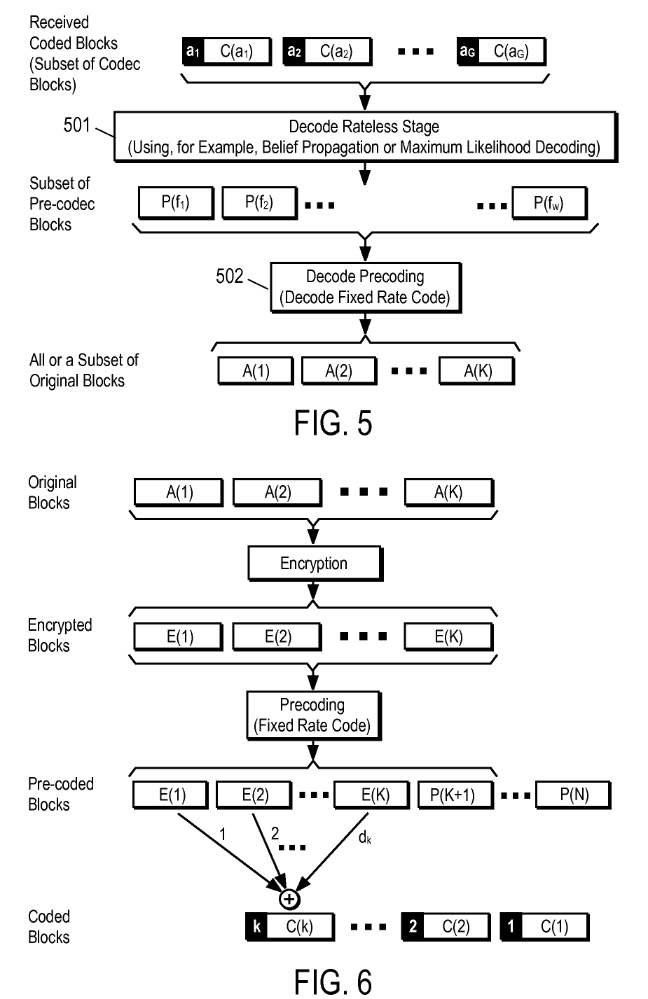

### DETAILED DESCRIPTION OF THE PRESENT INVENTION

Techniques are provided herein for a low-complexity method that can provide encryption to content that is encoded by a rateless code. In one embodiment, the technique includes a joint rateless coding and encryption scheme which allows encryption to take advantage of some of the properties of rateless codes. Rateless codes by nature are designed to be easy to decode. They also often produce “coded” blocks that are in fact copies of subsets of the original content (even without the need for any decoding operation). Therefore, by themselves, rateless codes do not provide strong encryption functionality or a good means to hide all the original content from an un-intended recipient.

One method that can provide encryption without using rateless codes is by either encrypting the original content prior to application of the rateless code, or by encrypting the rateless encoded content after application of the rateless code. These are discussed later. In both cases, an independent encryption/decryption operation is applied at the encoding/decoding steps in a system. In such embodiments, known classic encryption techniques are used for the encryption operation. However, such independent methods may require more operations than is sufficient for good (i.e. strong) encryption. It may also result in a system with higher computational complexity than is necessary. Specifically, these encryption techniques described do not take advantage of some of the underlying properties and operations of the rateless coding step, i.e., that is has cipher like operations. Embodiments of the invention described herein takes advantage of this rateless coding operation.

One can also encrypt only block identifiers. As described in the next section, this may be of lower complexity but is not secure

In one embodiment of the invention, a joint encryption/rateless coding method that is less complex than a system which considers independent application of the encryption and rateless code steps is used. By being less complex, the number of encryption/decryption operations required to transmit content securely when using a rateless code are reduced. Such a low complexity method is particularly attractive for mobile applications where lower complexity translates into less computation and thus properties such as extended battery life.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Basic Approaches

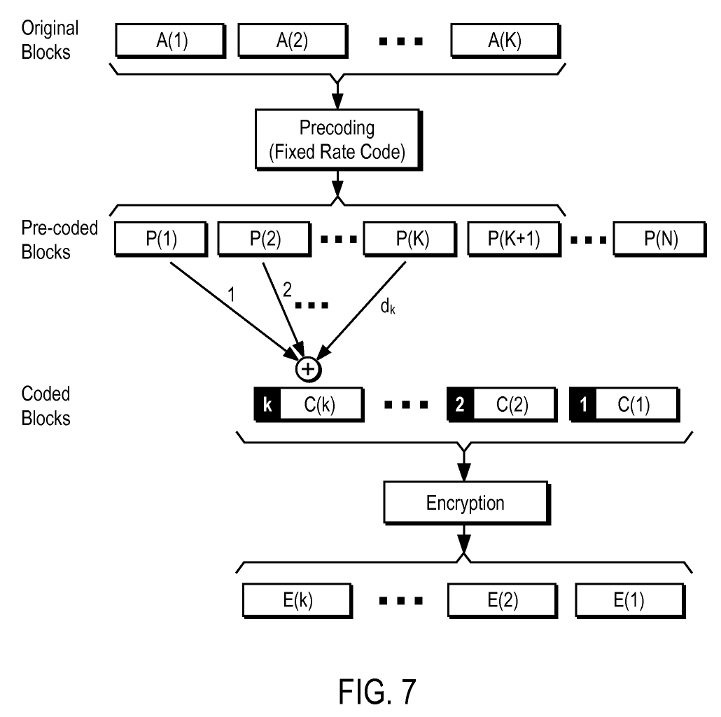

Two basic approaches to adding encryption to a system with rateless coding are simply to apply either encryption before or after the “precoding+rateless” step at the encoding. These two “independent encryption” approaches are shown in FIG. 6 and FIG. 7, respectively. The decoding procedures naturally follow. Of the two, it is expected that doing the encryption before may have lower complexity (in terms of both decoding and encoding) since there are fewer original message blocks than there are coded blocks. However, for large content sizes, i.e. large “K”, rateless codes become asymptotically efficient and the complexity difference between approaches may be small. Both approaches represent a trivial independent application of rateless coding with encryption.

Another approach is to apply the encryption during or within the pre-coding stage, i.e., use a (secret) fixed-rate code for the pre-coder. This, as in the approaches in FIG. 6 and FIG. 7, may be complex since encryption would be applied to all pre-coded blocks. Also, by definition, if the system is to be secure, the fixed-rate code used should have some minimal complexity. For example, at the very least it should be a non-systematic code and it also should probably be a non-linear code. One may also purposely add in additional artificial losses into the system, e.g. delete or corrupt some of coded blocks “P(k)” to further hide the identify of the information, relying on the error correcting capability of the fixed-rate code to recover it. This is used for example in the McEliece system where an addition “error” is added with no more than (N−K) errors. However, this compromises the use of the pre-coder to aid in the recovery of original content from a subset of ratelessly coded packets. Another weakness with this approach, prevalent in Unequal Error Protection schemes, is that pre-coding may not be applied to all original message blocks thus leaving some blocks unprotected. Of course, in some schemes encrypting only the high-priority information is sufficient to protect the identity of the low priority information, but this is not always the case.

Applying a second precoder, with a “secure” fixed-rate code to all packets, in addition to the original precoder, is another approach which essentially becomes similar to applying encryption before the final rateless stage. This second precoder can be applied either before or after the original precoder.

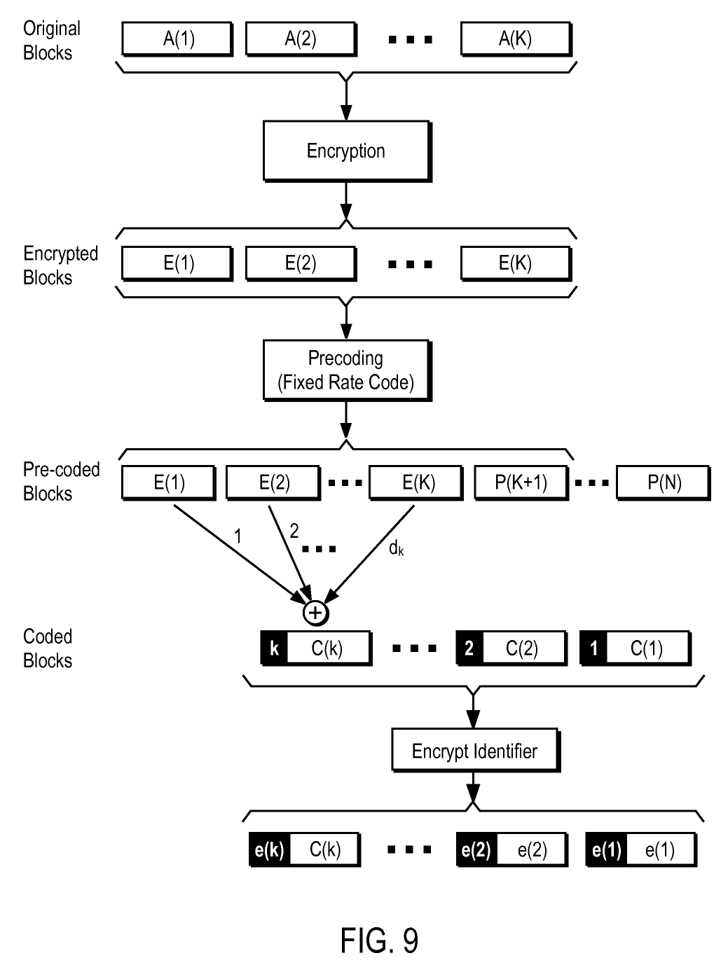

Another approach is to apply encryption only to the block identifier as shown in FIG. 9. This could be enhanced further by encrypting knowledge of the random number generator or method or process used to generate the degree values “dₖ” and block selections b(j,k). This way, even if an attacker obtains “k”, he may not be able to match it to values “dₖ” and block selections b(j,k). Therefore the identity of the coded content in each received block stays hidden.

This approach would be less complex than encrypting the original, pre-coded, or rateless coded information as described above since the Block Identifier itself represents a small number of bits.

However, this approach has an inherent weakness. First, it is not uncommon in rateless codes to have dₖ=1 for a non-trivial number of coded blocks, i.e., cases where no XOR-ing operation is used and a rateless coded block can in fact be equivalent to the underlying original information. For example, the degree distribution used in Raptor Codes is as below:

### DEGREE DISTRIBUTION EXAMPLE FOR RAPTOR CODES

p(1)=0.007969

p(2)=0.493570

p(3)=0.166220

p(4)=0.072646

p(5)=0.082558

p(8)=0.056058

p(9)=0.037229

p(19)=0.055590

p(64)=0.024023

p(66)=0.003135

p(n) for other values of n not above=0

In this case there is a non-trivial probability “p(1)” that a coded block contains un-XOR-ed original information from an original message block. If the information transmitted is text, e.g., email, it means that an unintended recipient can easily obtain (read) subsets of the original information regardless of whether the identifier is encrypted or not.

This presence of original information in received “coded” blocks may be easily identifiable even without knowing the identity, i.e. without knowing the “k”, the degree values “dₖ” and/or block selections b(j,k). For example, in the case of text, an attacker may simply use an automated process to search for words or phrases in received blocks. This would be an easy method to alert an attacker of packets with potentially un-XOR-ed information.

In the case of source coded media streams (e.g. streams of audio, speech, image or video), an attacker may simply apply various media decoders to the information in packets (coded block) until the media decoder indicates that the syntax in the stream contained within a packet is correct. The attacker may then further investigate the decoded output of such decoders. Thus, these “degree-1” coded blocks are a problem.

Such degree-1 blocks are not the entire source of the problem. Another problem is that at random an attacker can, with reasonable effort, obtain information that may have been coded with dₖ>1. This is due to the property that XOR-ing a degree “n−1” coded packet with a degree “n” coded packet can, with reasonable chance, generate original information. For example, take a case n=3, and assume that

$$C ( k ) = A ( b ( 1 , k ) ) + A ( b ( 2 , k ) )$$

$$C ( z ) = A ( b ( 1 , z ) ) + A ( b ( 2 , z ) ) + A ( b ( 3 , z ) ) \\ = A ( b ( 1 , k ) ) + A ( b ( 2 , k ) ) + A ( b ( 3 , z ) )$$

i.e.
b(1,z))=b(1,k) and b(2,z))=b(2,k) (two of the packets are common to both ratelessly coded packets)

It follows that even without having to know “k”, “z”, “dₖ”, “d_{z}”, “b(i,k)”, and/or “b(i,z)”, an attacker can simply try XOR-ing the packets to get

C(z)+C(k)=A(b(3,z))

A success in obtaining an original message block can be detected as with degree-1 coded packets as mentioned above.

An attacker or unintended recipient, on receiving “W” coded packets can, therefore, simply try all W×W XOR-ing combinations checking all for potential revelation of original blocks. One can further then try XOR-ing all such recovered blocks with the “W” coded packets to potentially retrieve more original blocks.

While it can be that only some packets may be recovered, and the re-ordering of such packets may not be possible, i.e., if “A(b(i,j))” is recovered it may still be difficult to identify “b(i,j)”, the system is not secure in the strongest sense. (Note, it may still be secure from the point of view of an attacker being able to say use the information to make or “stitch together” a reasonable stream for content, i.e., video or audio content, playback and/or piracy).

### Overview of Encryption of Selected Degrees

The techniques described herein produce an encryption scheme that is both secure and of lower-complexity than the examples presented above. These techniques avoid problems of these approaches:
1. It is less complex than the approaches that encrypt all the content, either before or after rateless coding
2. It avoids compromising the operation of the precoder.
3. It is secure, unlike the low-complexity method of only encrypting identifiers.
   a. If coded content is not fully encrypted, as in the approaches described in the Background Section, then degree 1 information is a weakness that makes the system less secure
   b. If coded content is not fully encrypted, as in the approaches described in the Background Section, then the presence of both degree “n” along with degree “n−1” information is a weakness that makes the system less secure.

To avoid these weaknesses, for a very secure system, embodiments of the invention use the principle that it is sufficient for strong encryption that all information that is XOR-ed with odd degree values, i.e. coded packets A(k) where dₖ=2y+1 for some positive integer y or y=0, is encrypted in a secure fashion. Thus, the existing XOR operations of a rateless code for even degrees are used for the purpose of encryption, and all that is needed is additional encryption of odd degrees. One can use any of the techniques in the Background Section for this purpose. In this manner, one can readily encrypt based on the degree value for the ratelessly coded block.

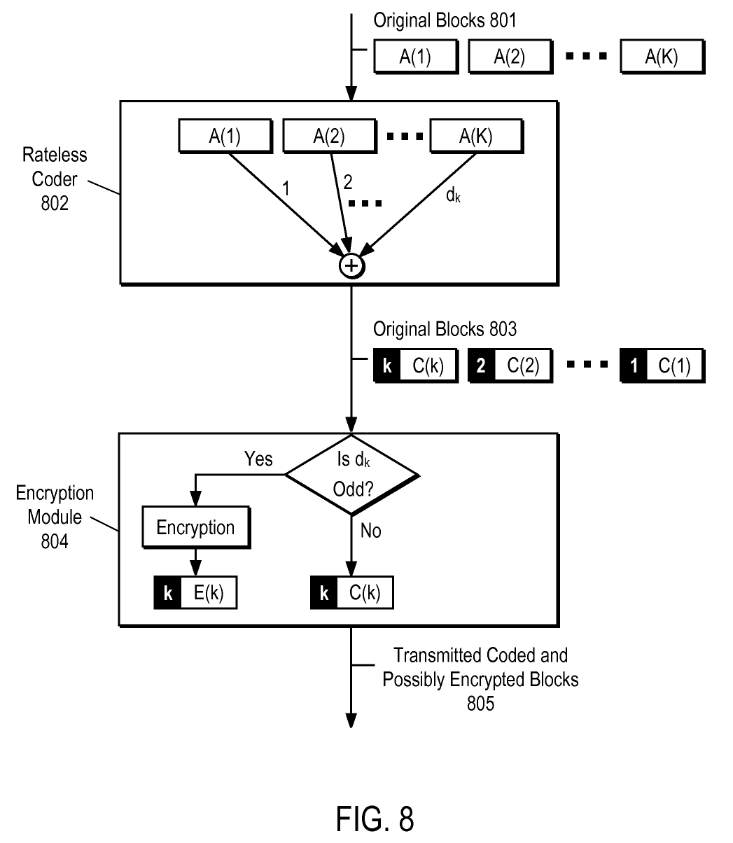

Again, one can do this with or without a pre-coding stage. The pre-coding stage is only included for illustration and can be removed where A(k) now substitutes for P(k) in the post-rateless encoding encryption process. FIG. 8 is a data flow diagram illustrating the encryption of coded blocks after a rateless coding stage. In this case, there is no preceding stage, though one could be included. Each of the units or modules may comprise hardware (circuitry, dedicated logic, etc.), software (such as is run on a general purpose computer system or a dedicated machine), or a combination of both.

Referring to FIG. 8, original blocks 801 comprise A(1), A(2), . . . A(K) and are input to rateless coder 802. Rateless coder 802 performs rateless coding as described above to produce coded blocks 803, which comprise coded blocks C(1), C(2), . . . C(k). Each of coded blocks 803 includes a block identifier. For example, block C(k) includes block identifier k, coded block C(2) includes block identifier 2, and coded block C(1) includes block identifier 1. Coded blocks 803 are input into an encryption module 804. Encryption module 804 encrypts coded blocks 803 based on a degree value for the rateless coded block to produce transmitted coded and possibly encrypted blocks 805. Note, the block identifier is not encrypted in this example, just the XOR-ed content. In one embodiment, encryption module 804 tests whether the degree associated with respect to each of the rateless coded blocks is odd. If the degree value for a ratelessly coded block is odd, the rateless coded block is encrypted; if the degree value for the ratelessly coded block is not odd, then the ratelessly coded block does not undergo encryption. Thus, the output of encryption module 804 comprises coded and possibly encrypted blocks 805.

Encrypting odd degree packets is sufficient since an attacker cannot, even by testing all possible combinations, obtain any original blocks. In the case of the degree n−1 and degree n combinations mentioned in the Background Section, at least one of the blocks is encrypted meaning that XOR procedures will not reveal any degree-1 results. Furthermore, any XOR combinations of degree 2n and 2j coded packets (combinations of even packets), or XOR combinations of degree 2n+1 and 2j+1 (odd) coded packets will result in, at the very least another packet of degree “d>1”. Applying any such packets with received packets, by induction arguments, will not produce any degree-1 (original) packets. Simply put, using a few examples of degree 2, 3, 4 and 5, it is true that:

encrypted(A+B+C)+encrypted(A+B+C+D+E)=random bits (bits that are of no use) 1.

(A+B)+(A+B+C+D)=C+D 2.

encrypted(A+B+C)+(A+B+C+D)=random bits 3.

Here “encrypted(X)” refers to the process/function of encrypting “X”, and “+” is the bit-wise XOR of the symbols as previously defined.

The encryption techniques described herein can be further enhanced by hiding knowledge of the code used for pre-coding and/or hiding/encrypting knowledge of the random number generator or method used to generate the degree values “dₖ” and block selections b(j,k). By hiding the identity of the generator and/or the state of the generator, an attacker can be prevented from reproducing the operation of the random number generator. Such hiding may occur by having the encrypting device, or the method, used to generate the degree values dₖ and block selections, exchanged securely between the transmitter and an intended recipient using known public key sharing methods and or by using a different sideband channel than over which the coded data is sent. Note hiding this knowledge is of use only in conjunction with the underlying encryption of the ratelessly coded data as described above and below.

One can also consider other methods to encrypt based on the degree number. For example, one may encrypt all rateless coded blocks with dₖ=1 and dₖ=even value, i.e. encrypt all but those packets with odd degree values greater than 1. One may also decide, based on the specifics of the degree distribution, to, or not to, encrypt additional degree values. For example, in the “Degree Distribution Example” for Raptor codes show above, one may chose not to encrypt blocks using dₖ=19. This is because there are no values dₖ=18 or dₖ=20, and generation of degree-1 (using combinations of 2 or more of the other degree values) is a bit more difficult than simply checking “W×W” combinations.

There are a number of advantages with this approach. One advantage is significant complexity reduction in decrypting operations at the receiver compared to other methods mentioned in the Background Section. It is also possible to see significant complexity reduction in encrypting operations at the transmitter compared to other methods mentioned in the Background Section.

In short, the techniques described herein produce a secure stream where not all rateless coded packets are encrypted, and for which is it not necessary to encrypt all packets to have a secure stream. In fact, if one considers the degree distribution example described above and a scenario where only odd degree packets are encrypted, the probability of encryption would be

p(1)+p(3)+p(5)+p(9)+p(19)=0.349566

i.e., only about 35% of coded packets are encrypted.

If the number of received packets is close to “N” or “K”, this would be close to a 35% reduction in computation of decrypting compared to the methods described above in conjunction with FIGS. 6 and 7. Since decrypting can be a computationally complex process, the techniques described herein are well suited for applications with mobile (battery powered) receivers. Even when the number of received packets grows to the order of “2N”, the techniques described herein still have advantages. In such cases, the rateless code is in fact not being applied efficiently anyway.

If the number of transmitted packets is close to “N” or “K”, then there is also close to a 35% reduction of computation of encrypting compared to methods described above in conjunction with FIGS. 6 and 7 Such cases would include cases where the rateless code is close to being asymptotically efficient and the number of transmissions are limited by the scenario (such as a case of serving one or more receivers in near synchronization, or being able to use the same rateless packets with high probability for multiple users).

There may be scenarios where the transmitter generates significantly more than “N” coded packets, e.g. in cases where a ratelessly encoded stream serves many users over different periods of time, and/or many packets are lost in transmission. But even in such a case, once the number of generated packets is less than approximately 3N, the transmitter may still save in computation. Regardless, in this case, the receivers save in computation as described in the previous paragraph.

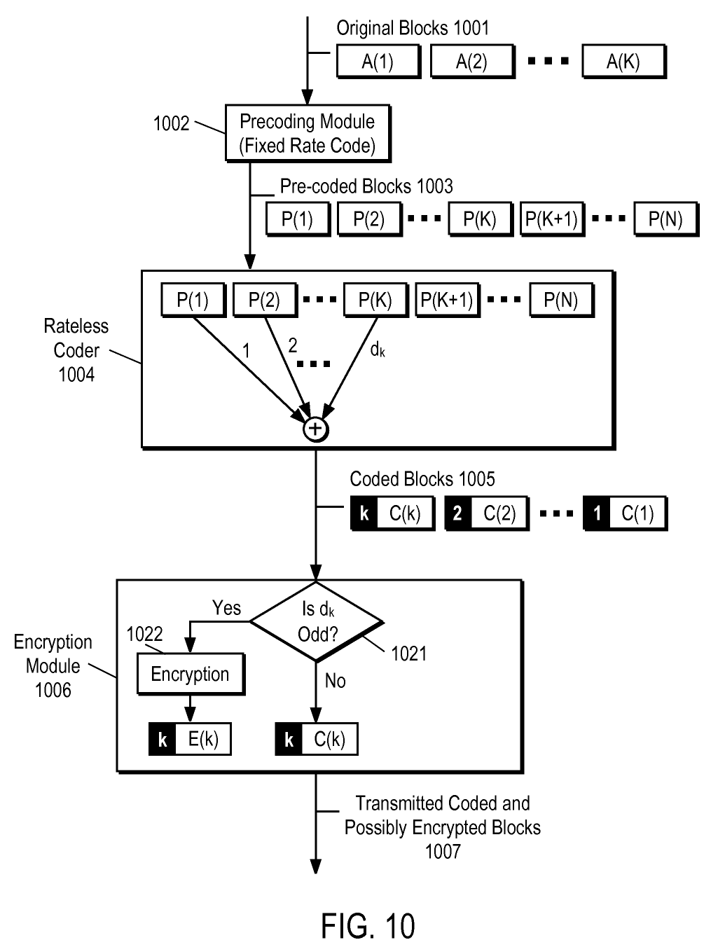

In one embodiment, at the encoder, the system simply encrypts based on whether or not the degree value is odd. FIG. 10 is a data flow diagram illustrating the encryption of coded blocks after a rateless coding stage that is preceded by a pre-coding stage. Each of the units or modules may comprise hardware (circuitry, dedicated logic, etc.), software (such as is run on a general purpose computer system or a dedicated machine), or a combination of both.

Referring to FIG. 10, original blocks 1001 comprise A(1), A(2), . . . A(K) and are input to precoding module 1002. Precoding module 1002 uses a fixed rate code and produces pre-coded blocks 1003, which comprise P(1), P(2), . . . , P(K), P(K+1), . . . , P(N). Rateless coder 1004 receives pre-coded blocks 1003 and performs rateless coding as described above to produce coded blocks 1005, which comprise coded blocks C(k), . . . , C(2), and C(1). Each of coded blocks 1005 includes a block identifier. For example, block C(k) includes block identifier k, coded block C(2) includes block identifier 2, and coded block C(1) includes block identifier 1. Coded blocks 1005 are input into an encryption module 1006. Note, as shown in FIG. 10 in one embodiment the block identifiers are not encrypted.

Encryption module 1006 encrypts coded blocks 1005 based on a degree value for the rateless coded block to produce transmitted coded and possibly encrypted blocks 1007. In one embodiment, encryption module 1006 includes testing module 1021 to tests whether the degree associated with respect to each of the rateless coded blocks is odd. If testing module 1021 determines the degree value for a ratelessly coded block is odd, then block encryption module 1022 encrypts that rateless coded block; if testing module 1021 determines the degree value for the ratelessly coded block is not odd, then that ratelessly coded block does not undergo encryption. Thus, the output of encryption module 1007 comprises coded and possibly encrypted blocks 1007. Note that the block identifier for the ratelessly coded blocks is not encrypted regardless of whether the coded blocks are encrypted or not.

In one embodiment, these encryption operations are performed in a transmitter or in conjunction with a transmitter that is responsible for transmitting content. In one embodiment, the transmitter may be part of a server or content server on a wired internet. In another embodiment, the transmitter may be part of a wired computer. In other embodiments, the transmitter may be part of a base-station (i.e., a wireless component) or a mobile phone or other mobile device.

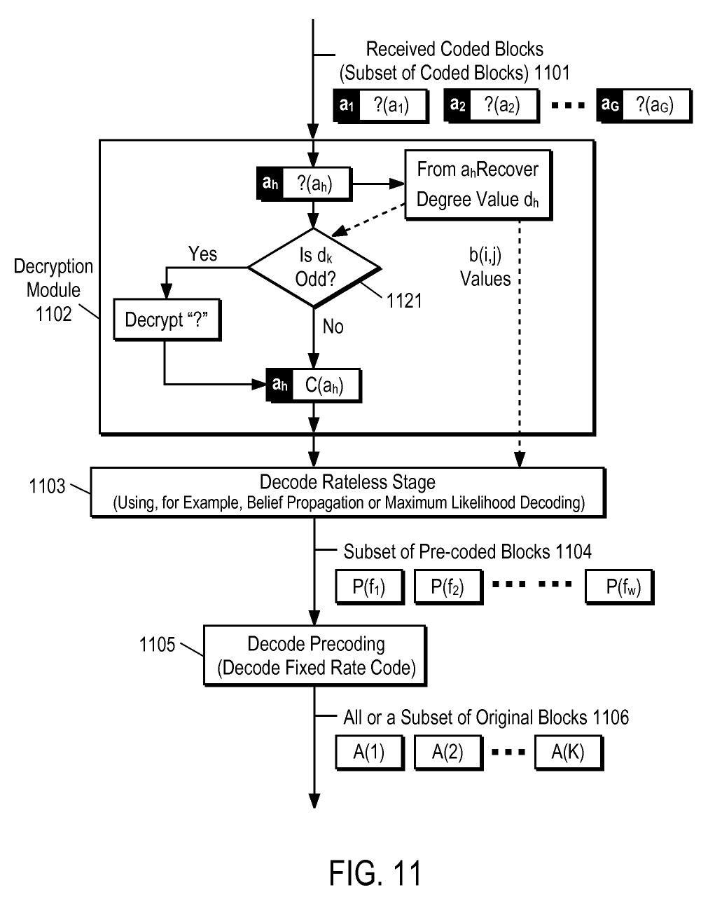

FIG. 11 is a data flow diagram illustrating the decryption of coded blocks prior to a decode rateless stage. Pre-coding is illustrated though the basic flow also corresponds to FIG. 8 if one ignores the decoding operation for pre-coding. In essence, FIG. 11 illustrates the decoding operation that reverses the coding operation illustrated in FIG. 10. Each of the units or modules may comprise hardware (circuitry, dedicated logic, etc.), software (such as is run on a general purpose computer system or a dedicated machine), or a combination of both.

Referring to FIG. 11, received coded blocks 1101 are input to decryption module 1102 and comprise ?(a₁), ?(a₂), . . . , ?(a_{G}), where “?” refers to a coded packet that may or may not be encrypted. Each of coded blocks 101 includes a block identifier. For example, coded block ?(a₁) includes block identifier a₁, coded block ?(a₂) includes block identifier a₂, and coded block ?(a_{G}) includes block identifier a_{G}. Decryption module processes each of coded blocks 1101 one block at a time and performs decryption based on degree value in the same manner as described in FIG. 10. Using the degree value aₕ, decryption module 1102 recovers the degree value dₕ, as well as the b(i,j) values. In one embodiment, this is performed using the block identifier that has this information, either implicit on the “k” or through additional information in the identifier. Using the recovered degree value, a testing module 1121 in decryption module 1102 determines if the degree value is odd. If so, decryption module 1102 performs decryption on the received coded block; otherwise, decryption module 1102 passes the coded block without performing a decryption operation on the coded block. Therefore, decryption module 1102 outputs coded blocks and decrypted blocks, as well as the b(i,j) values.

The coded blocks and decrypted blocks, as well as the b(i,j) values, output from decryption module 1102 are input into decode rateless stage 1103 that performs rateless decoding on the coded blocks and decrypted blocks received from decryption module 1102. Decode rateless stage 1102 may use Belief Propagation, Maximum Likelihood Decoding, or another well-known rateless decoding technique. The result of the decoding operation comprise a subset of pre-coded blocks 1104, which are shown as P(f₁), P(f₂), . . . , P(f_{w}).

Decode preceding stage 1105 receives pre-coded blocks 1104 and decodes the precoded blocks. In one embodiment, decode precoding stage 1105 uses a decode fixed rate code to perform the decoding. The results of the decoding are output from decode preceding stage 1105 as all or a subset of original blocks 1106, shown as A(1), A(2), . . . A(K).

In one embodiment, these decryption and decoding operations are performed by, or in conjunction with, a receiver that receives the content.

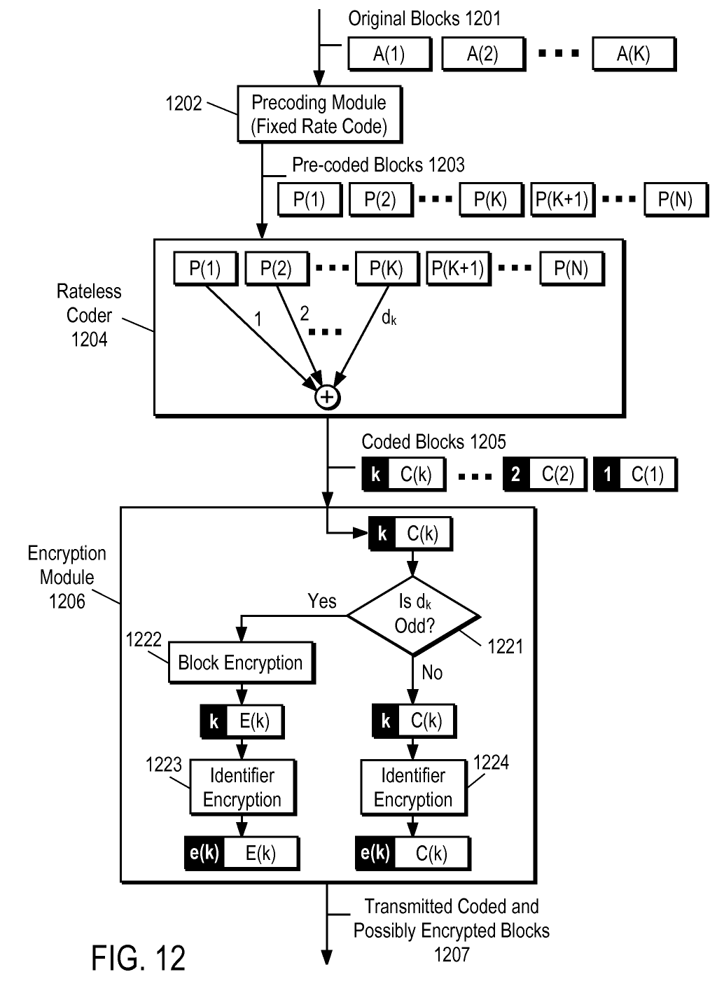

In another embodiment, in addition to encrypting coded blocks, the also encode the block identifiers. This “Identifier Encryption” can be done either before or after the “Block Encryption”. In this case, it is important that the encryption of the payloads and encryption of the identifier is separate. By doing so, one can get the identifier independent of decrypting the payload. In FIG. 12, the encoding procedure is shown, without loss in generality, of “Identifier Encryption” done after “Block Encryption”. Each of the units or modules in FIG. 12 may comprise hardware (circuitry, dedicated logic, etc.), software (such as is run on a general purpose computer system or a dedicated machine), or a combination of both.

Referring to FIG. 12, original blocks 1201 comprise A(1), A(2), . . . A(K) and are input to precoding module 1202. Precoding module 1202 uses a fixed rate code and produces pre-coded blocks 1203, which comprise P(1), P(2), . . . , P(K), P(K+1), . . . , P(N). Rateless coder 1204 receives pre-coded blocks 1203 and performs rateless coding as described above to produce coded blocks 1205, which comprise coded blocks C(k), . . . , C(2), and C(1). Each of coded blocks 1205 includes a block identifier. For example, block C(k) includes block identifier K, coded block C(2) includes block identifier 2, and coded block C(1) includes block identifier 1. Coded blocks 1205 are input into an encryption module 1206.

Encryption module 1206 encrypts coded blocks 1205 based on a degree value for the rateless coded block to produce transmitted coded and possibly encrypted blocks 1207. In one embodiment, encryption module 1206 includes testing module 1221 to tests whether the degree associated with respect to each of the rateless coded blocks is odd. If testing module 1221 determines the degree value for a ratelessly coded block is odd, then block encryption module 1222 encrypts that rateless coded block; if testing module 1221 determines the degree value for the ratelessly coded block is not odd, then that ratelessly coded block does not undergo encryption. Regardless of the degree value, encryption module 1206 encrypts the block identifier for the ratelessly coded blocks using identifier encryption modules 1223 and 1224. Thus, the output of encryption module 1207 comprises coded and possibly encrypted blocks 1007, in which all of the blocks have encrypted block identifiers.

Again, one can do this with or without a pre-coding stage. The pre-coding stage is only included for illustration and can be removed where A(k) is substituted for P(k) in the encryption process described above.

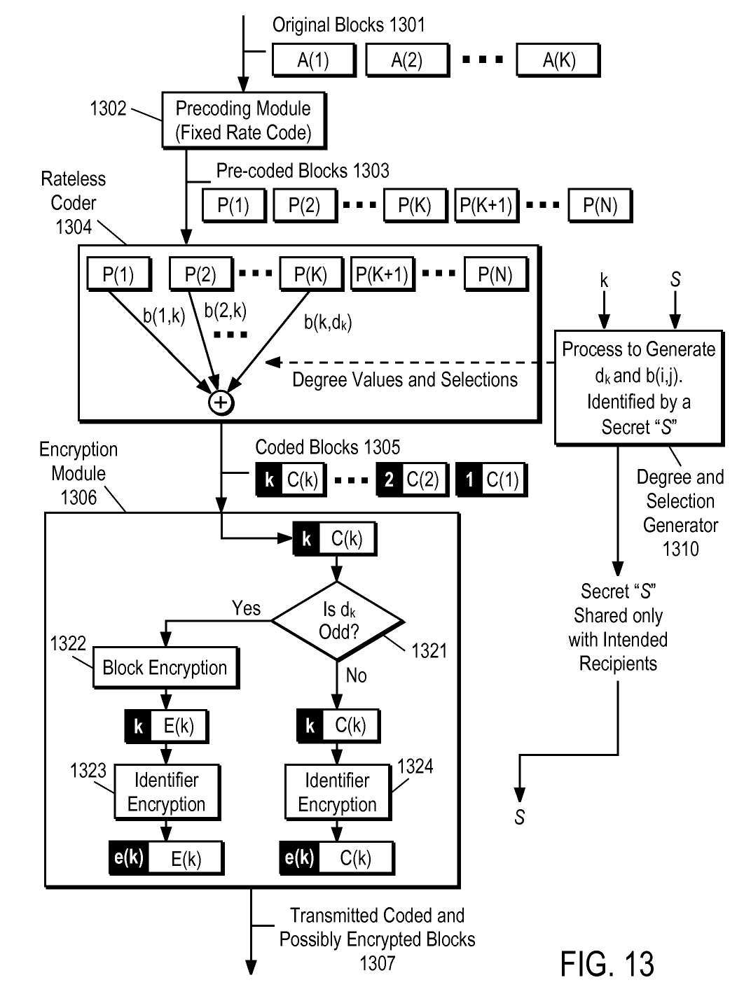

In another embodiment, the encoding process is to enhance by further hiding knowledge of the random number generator or method used to generate the degree values “dₖ” and block selections b(j,k). This enhancement may be added to any of the embodiments described above, such as those in FIGS. 10, 11 and 12. FIG. 13 is a flow diagram of one embodiment of the encoding process of FIG. 12 with the addition of hiding knowledge of the random number generator or method used to generate the degree values “dₖ” and block selections b(j,k). Each of the units or modules in FIG. 13 may comprise hardware (circuitry, dedicated logic, etc.), software (such as is run on a general purpose computer system or a dedicated machine), or a combination of both.

Referring to FIG. 13, original blocks 1301 comprise A(1), A(2), . . . A(K) and are input to preceding module 1302. Precoding module 1302 uses a fixed rate code and produces pre-coded blocks 1303, which comprise P(1), P(2), . . . , P(K), P(K+1), . . . , P(N). Rateless coder 1304 receives pre-coded blocks 1303 from preceding module 1302 and degree values and selections from degree and selection block generator 1310 and performs rateless coding as described above to produce coded blocks 1305, which comprise coded blocks C(k), . . . , C(2), and C(1). Degree and selection block generator 1310 receives k and a secret S and, using these values, performs a process to generate dₖ and b(i,j). Degree and selection block generator 1310 is common to both the transmitter and receiver, e.g. the same random number generator or generators with the same state or states are used. Based on “k” and the shared secret “Y” this module generates the degree values and the packet selections. Thus, to identify the k-th packet, assuming that the secret “S” is shared between transmitter and intended receiver, all that is needed to handle the decoding of an incoming packet is to identify the block identifier “k.” This is then sufficient to obtain the same numerical selections (degree value, packet selections) for the k-th packet, since the random number generator at the receiver generates the same sequence of random numbers as at the transmitter. The shared secret S defining such a state can be exchanged between sender and receiver(s) using a variety of existing public-share key or other basic encryption methods. Of course, the block identifier of the packet can always be simply the raw packet selections that make up the ratelessly coded packet, though this would make for a longer identifier since it would consist of (for packet k) up to dₖ numbers.

Each of coded blocks 1305 includes a block identifier. For example, block C(k) includes block identifier K, coded block C(2) includes block identifier 2, and coded block C(1) includes block identifier 1. Coded blocks 1305 are input into an encryption module 1306.

Encryption module 1306 encrypts coded blocks 1305 based on a degree value for the rateless coded block to produce transmitted coded and possibly encrypted blocks 1307. In one embodiment, encryption module 1306 includes testing module 1321 to tests whether the degree associated with respect to each of the rateless coded blocks is odd. If testing module 1321 determines the degree value for a ratelessly coded block is odd, then block encryption module 1322 encrypts that rateless coded block; if testing module 1321 determines the degree value for the ratelessly coded block is not odd, then that ratelessly coded block does not undergo encryption. Regardless of the degree value, encryption module 1306 encrypts the block identifier for the ratelessly coded blocks using identifier encryption modules 1323 and 1324. Thus, the output of encryption module 1307 comprises coded and possibly encrypted blocks 1307, in which all of the blocks have encrypted block identifiers.

Again, the above process can occur with or without a pre-coding stage. The pre-coding stage is only included for illustration and can be removed where A(k) now substitutes for P(k) in the encryption process.

The embodiments describe above may be modified so that only degree-1 coded blocks are encrypted. Though this has weaknesses outlined above, i.e. unencrypted degree n−1 and n blocks can still reveal original blocks by exhaustive searches, this modification may serve as a “weak encryption” method hiding information from casual unintended recipients.

The embodiments described above may be modified to hide the knowledge of the pre-coding stage from unintended recipients. This could be done using basic encryption techniques. In one embodiment, for example, this is accomplished by randomly selecting one code from a family of codes.

The embodiments described above may use other methods to decide whether or not to perform encryption based on the degree number. For example, in one embodiment, the system encrypt all rateless coded blocks with dₖ=1 and dₖ=even value, i.e. encrypt all but odd values>1. In another embodiment, the decision on whether to encrypt is based on the specifics of the degree distribution, to, or not to, encrypt additional degree values. For example, in one embodiment, in the “Degree Distribution Example” for Raptor codes show above, the system chooses not to encrypt blocks using dₖ=19. This is because there are no values dₖ=18 or dₖ=20, and generation of degree-1 (using combinations of 2 or more of the other degree values) is a bit more difficult than simply checking “W×W” combinations. In another embodiment, a probabilistically decision is made as to whether or not to encrypt packets, where the probability depends on the degree value.

In yet another embodiment, the methods where the present block selection and degree value, and also prior block selections and degree values, enter into a process to decide when to encrypt are modified. For example, if a coded packet C(k)=a+b+c and it is known that no packet for C(j), j<k, has a+b, a+c, or a+c, or a+b+c+x, where “x” is some other block, a decision may be made that it is safe not to encrypt C(k).

Similarly, if one can determine that no pre-coded packet, which is itself not equivalent to an original content packet, can be recovered by XOR-ing any previous ratelessly coded packet one may decide not to encrypt. That is, if it is determined that only a parity block from the pre-coded content may be recovered from randomly combining previously transmitted packets, not encrypting may still be sufficient to hide the identity of the original (uncoded) content.

Again, these embodiments may include or not include a pre-coding stage. The pre-coding stage is only included for illustration and can be removed where A(k) now substitutes for P(k) in the encryption process.

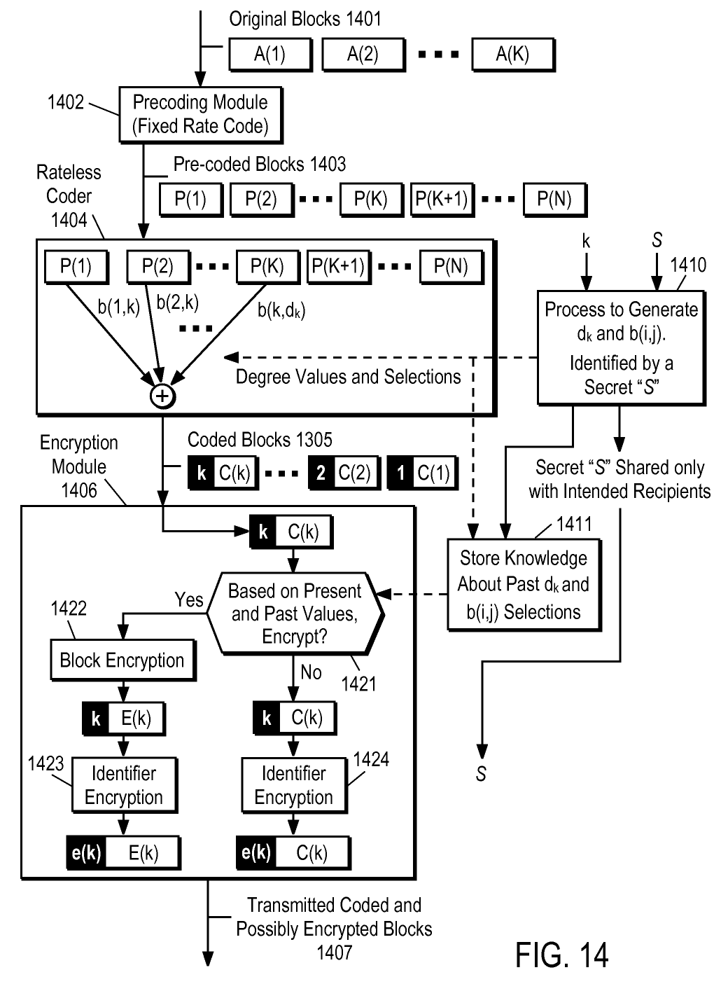

FIG. 14 shows an example of one such case in which FIG. 13 has been modified to include the enhancement described above. Each of the units or modules in FIG. 13 may comprise hardware (circuitry, dedicated logic, etc.), software (such as is run on a general purpose computer system or a dedicated machine), or a combination of both.

Referring to FIG. 14, original blocks 1301 comprise A(1), A(2), . . . A(K) and are input to preceding module 1402. Precoding module 1402 uses a fixed rate code and produces pre-coded blocks 1403, which comprise P(1), P(2), . . . , P(K), P(K+1), . . . , P(N). Rateless coder 1404 receives pre-coded blocks 1403 from preceding module 1402 and degree values and selections from degree and selection block generator 1410 and performs rateless coding as described above to produce coded blocks 1405, which comprise coded blocks C(k), . . . , C(2), and C(1). Degree and selection block generator 1410 receives k and a shared secret S and, using these values, performs a process to generate dₖ and b(i,j). As discussed above, the shared secret S can be exchanged between sender and receiver(s) using a variety of basic encryption methods The secret S is stored along with past (recovered) dₖ and b(i,j) selections at processing block 1411 and allows one to generate any of the dₖ and b(i,j) for the packets, once a unique identifier of the packet, such as its number “k”, is retrieved.

Each of coded blocks 1405 includes a block identifier. For example, block C(k) includes block identifier K, coded block C(2) includes block identifier 2, and coded block C(1) includes block identifier 1. Coded blocks 1405 are input into an encryption module 1406.

Encryption module 1406 encrypts coded blocks 1405 based on a degree value for the rateless coded block to produce transmitted coded and possibly encrypted blocks 1407. In one embodiment, encryption module 1406 includes testing module 1421 to tests present (e.g., the degree value for a ratelessly coded block being coded) and past degree values to determine whether to encrypt. If testing module 1421 determines to encrypt the coded blocks, then block encryption module 1422 encrypts that rateless coded block; if testing module 1421 determines that based on past and present degree values encryption should not occur, then that ratelessly coded block does not undergo encryption. Regardless of the degree value, encryption module 1406 encrypts the block identifier for the ratelessly coded blocks using identifier encryption modules 1423 and 1424. Thus, the output of encryption module 1407 comprises coded and possibly encrypted blocks 1407, in which all of the blocks have encrypted block identifiers.

There are number of target scenarios that may be used by the techniques described. These include any scenario where rateless codes are used to transmit sensitive media/data that needs to be secured. These are usually cases where a number of users want to receive the same content, but users are either seeing very different channel conditions (losses in packets), and/or are not downloading the content or packets at the same time, and/or where a user may download the content in disjoint time intervals. For example, the scenarios may include software updates where users do the updates incrementally over time or at different times, Peer to Peer “P2P” scenarios where connections between different “Peers” can be very different, sending content that is distributed among many servers, periodic broadcasting architectures (e.g., “Skyscraper” systems) which support streaming applications where users connect asynchronously yet all can see fast playback times.

### AN EXAMPLE OF A COMPUTER SYSTEM

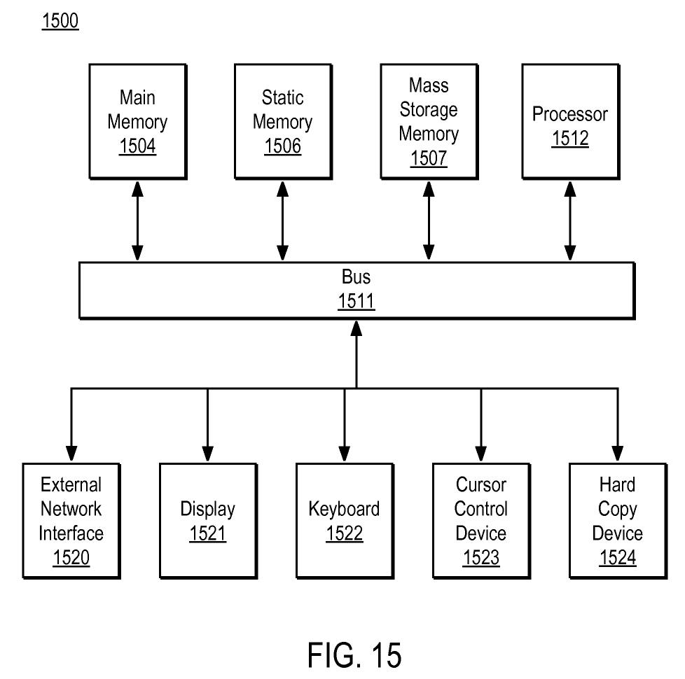

FIG. 15 is a block diagram of an example of a computer system that may perform one or more of the operations described herein. Referring to FIG. 15, computer system 1500 may comprise an exemplary client or server computer system. Computer system 1500 comprises a communication mechanism or bus 1511 for communicating information, and a processor 1512 coupled with bus 1511 for processing information. Processor 1512 includes a microprocessor, but is not limited to a microprocessor, such as, for example, Pentium™, PowerPC™, Alpha™, etc.

System 1500 further comprises a random access memory (RAM), or other dynamic storage device 1504 (referred to as main memory) coupled to bus 1511 for storing information and instructions to be executed by processor 1512. Main memory 1504 also may be used for storing temporary variables or other intermediate information during execution of instructions by processor 1512.

Computer system 1500 also comprises a read only memory (ROM) and/or other static storage device 1506 coupled to bus 1511 for storing static information and instructions for processor 1512, and a data storage device 1507, such as a magnetic disk or optical disk and its corresponding disk drive. Data storage device 1507 is coupled to bus 1511 for storing information and instructions.

Computer system 1500 may further be coupled to a display device 1521, such as a cathode ray tube (CRT) or liquid crystal display (LCD), coupled to bus 1511 for displaying information to a computer user. An alphanumeric input device 1522, including alphanumeric and other keys, may also be coupled to bus 1511 for communicating information and command selections to processor 1512. An additional user input device is cursor control 1523, such as a mouse, trackball, trackpad, stylus, or cursor direction keys, coupled to bus 1511 for communicating direction information and command selections to processor 1512, and for controlling cursor movement on display 1521.

Another device that may be coupled to bus 1511 is hard copy device 1524, which may be used for marking information on a medium such as paper, film, or similar types of media. Another device that may be coupled to bus 1511 is a wired/wireless communication capability 1525 to communication to a phone or handheld palm device.

Note that any or all of the components of system 1500 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

I claim:

1. A method comprising:
performing rateless coding on a first set of blocks of data to produce ratelessly encoded blocks of data; and
performing encryption on a subset of the ratelessly encoded blocks of data based on a degree value for each of the ratelessly encoded blocks of data.

2. The method defined in claim 1 wherein performing rateless coding comprises performing an XOR operation on information, at least some of the information using odd degree values.

3. The method defined in claim 1 further comprising performing preceding on a plurality of content blocks to produce the first set of blocks.

4. The method defined in claim 1 wherein performing encryption on a subset of the ratelessly encoded blocks comprises encrypting blocks in the ratelessly encoded blocks having odd degree values.

5. The method defined in claim 1 wherein performing encryption on a subset of the ratelessly encoded blocks comprises additionally encoding block identifiers of blocks in the ratelessly encoded blocks.

6. The method defined in claim 1 further comprising encoding block identifiers of the ratelessly encoded blocks before or after performing encryption on a subset of the ratelessly encoded blocks.

7. The method defined in claim 1 further comprising hiding knowledge of one or both of a meaning of the block identifier which can include the identity of the random number generator or method used to generate degree values and block selections.

8. The method defined in claim 7 wherein hiding knowledge of one or both of a random number generator or method used to generate degree values and block selections is based on a secret exchanged between an encryption system performing the encryption of the subset of ratelessly encoded blocks and a decryption system that will decrypted encrypted versions of the subset of ratelessly encoded blocks.

9. The method defined in claim 1 wherein performing encryption on a subset of the ratelessly encoded blocks of data comprises performing encryption on only those blocks of the ratelessly encoded blocks having a degree value dₖ equal to 1.

10. The method defined in claim 1 wherein performing encryption on a subset of the ratelessly encoded blocks of data comprises performing encryption on only those blocks of the ratelessly encoded blocks having a degree value dₖ equal to 1 or a degree value dₖ equals an even value.

11. The method defined in claim 1 wherein performing encryption on a subset of the ratelessly encoded blocks of data based on a degree value for each of the ratelessly encoded blocks of data comprises determining whether to encrypt based on a degree distribution.

12. The method defined in claim 1 wherein performing encryption on a subset of the ratelessly encoded blocks of data based on a degree value for each of the ratelessly encoded blocks of data comprises determining probabilistically whether to encrypt based a degree distribution.

13. The method defined in claim 1 wherein performing encryption on a subset of the ratelessly encoded blocks of data based on a degree value for each of the ratelessly encoded blocks of data comprises determining whether to encrypt based the present and past block selections and present and past degree values.

14. An apparatus comprising:
a rateless coder to perform rateless coding on a first set of blocks of data to produce ratelessly encoded blocks of data; and
an encryption module to perform encryption on a subset of the ratelessly encoded blocks of data based on a degree value for each of the ratelessly encoded blocks of data.

15. The apparatus defined in claim 14 where the rateless coding step has a pre-coding operation and wherein the encryption module is operable to perform selective encryption based additionally or separately on whether the ratelessly encoded block was made of pre-coded blocks that are parity blocks or of pre-coded blocks that are equivalent to original information blocks.

16. The apparatus defined in claim 14 wherein the rateless coder is operable to perform rateless coding by performing an XOR operation on information with odd degree values.

17. The apparatus defined in claim 14 further comprising a precoder to perform preceding on a plurality of content blocks to produce the first set of blocks.

18. The apparatus defined in claim 14 wherein the encryption module performs encryption on a subset of the ratelessly encoded blocks by encrypting blocks in the ratelessly encoded blocks having odd degree values.

19. The apparatus defined in claim 14 wherein the encryption module is operable to encode block identifiers of blocks in the ratelessly encoded blocks.

20. The apparatus defined in claim 19 wherein the encryption module is operable to encode block identifiers of the ratelessly encoded blocks before or after performing encryption on a subset of the ratelessly encoded blocks.

21. The apparatus defined in claim 14 further comprising a processing block to hide knowledge of one or both of a random number generator or method used to generate degree values and block selections.

22. The apparatus defined in claim 21 wherein the process block hides knowledge of one or both of a random number generator or method used to generate degree values and block selections using a secret exchanged between the apparatus and a decryption system that will decrypted encrypted versions of the subset of ratelessly encoded blocks.

23. The apparatus defined in claim 14 wherein the encryption module is operable to perform encryption on a subset of the ratelessly encoded blocks of data by performing encryption on only those blocks of the ratelessly encoded blocks having a degree value dₖ equal to 1.

24. The apparatus defined in claim 14 wherein the encryption module is operable to perform encryption on a subset of the ratelessly encoded blocks of data by performing encryption on only those blocks of the ratelessly encoded blocks having a degree value dₖ equal to 1 or a degree value dₖ equals an even value.

25. The apparatus defined in claim 14 wherein the encryption module is operable to perform encryption on a subset of the ratelessly encoded blocks of data by determining whether to encrypt based on a degree distribution.

26. The apparatus defined in claim 14 wherein the encryption module is operable to perform encryption on a subset of the ratelessly encoded blocks of data by determining probabilistically whether to encrypt based a degree distribution.

27. The apparatus defined in claim 14 wherein the encryption module is operable to perform encryption on a subset of the ratelessly encoded blocks of data by determining whether to encrypt based the present and past block selection and degree values.

28. An article of manufacture having one or more computer readable storage media storing instructions thereon which, when executed by a system, cause the system to perform a method comprising:
performing rateless coding on a first set of blocks of data to produce ratelessly encoded blocks of data; and
performing encryption on a subset of the ratelessly encoded blocks of data based on a degree value for each of the ratelessly encoded blocks of data.

29. An apparatus comprising:
a decryption module to decrypt a subset of a plurality coded blocks based on degree value for each of the coded blocks; and
a decoder to perform rateless decoding on the subset of coded blocks that underwent decryption by the decryption module and other coded blocks of the plurality of coded blocks that did not undergo decryption by the decryption module.
